(19) United States
(12) Patent Application Publication
(10) Pub. No.: US 2018/0096008 A1
(43) Pub. Date: Apr. 5, 2018

(54) Computing System for Automatically Obtaining Gender Data in a Social Data Network

(71) Applicant: Sysomos L.P., Toronto (CA)

(72) Inventors: Koushik PAL, Etobicoke (CA); Edward Dong-Jin KIM, Toronto (CA); Kanchana PADMANABHAN, Toronto (CA)

(73) Assignee: Sysomos L.P., Toronto (CA)

(21) Appl. No.: 15/447,535

(22) Filed: Mar. 2, 2017

Related U.S. Application Data
(60) Provisional application No. 62/403,353, filed on Oct. 3, 2016.

(51) Int. Cl. G06F 17/30; H04L 29/08

(52) U.S. Cl. CPC G06F 17/30312; G06Q 30/0204; G06F 17/30477; H04L 67/306

(57) ABSTRACT

In social data networks, it is difficult for a computing system to automatically identify gender attributes associated with user accounts because of incorrect, incomplete or non-existent data associated with the user account profile. Therefore, a computing system is provided that retrieves user account data and related text data, and that uses classification to identify gender data. Label propagation computations based on the connections in the social data network are used to infer the gender information of many user accounts at the same time.

### CROSS-REFERENCE TO RELATED APPLICATIONS

This application claims priority to U.S. Provisional Patent Application No. 62/403,353 filed on Oct. 3, 2016, entitled “Computing System for Automatically Obtaining Gender Data in a Social Data Network” and the entire contents of which is incorporated herein by reference.

### TECHNICAL FIELD

The following generally relates to a computing system for automatically obtaining gender data in a social data network.

### DESCRIPTION OF THE RELATED ART

The amount of data being created by people using electronic devices, or simply data obtained from electronic devices, has been growing over the last several years. Digital data is created and transmitted over various social media. This data often includes attributes about a person, or people. These attributes may include their gender. Gender data, for example, is obtained or identified using metadata, tags, user-profile forms, etc. These attributes are used, for example, by digital organizations to provide targeted advertising, targeted product and service offerings, targeted digital content (e.g. news articles, videos, posts, etc.), or combinations thereof. In some cases, attributes, including gender, about a person are used for verification or digital security purposes.

However, attributes about a person or people are often incomplete, or incorrect, or even non-existent. For example, a person may purposely withhold their gender information or may provide false information about themselves. This incomplete, incorrect or altogether missing digital data therefore disrupts the effectiveness of down-stream software applications and computing systems that use the attribute data.

### BRIEF DESCRIPTION OF THE DRAWINGS

Embodiments will now be described by way of example only with reference to the appended drawings wherein:

FIG. 1 is an example of a social network graph comprising nodes and edges.

FIG. 2 is a system diagram including a server system in communication with other computing devices.

FIG. 3 is a schematic diagram showing another example embodiment of the server system of FIG. 2, but in isolation.

FIG. 4 is an example embodiment of a server system architecture, also showing the flow of information amongst databases and modules.

FIG. 5 is a flow diagram showing example executable instructions for obtaining gender data in a social data network.

FIG. 6 is a flow diagram showing example executable instructions for computing an initial list of user account having known genders.

FIG. 7 is a flow diagram showing example executable instructions for computing an intermediary list of seed users.

FIG. 8 is a flow diagram showing example executable instructions for computing an inferred gender of a user in the social data network, based on the seed users.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures and components have not been described in detail so as not to obscure the example embodiments described herein. Also, the description is not to be considered as limiting the scope of the example embodiments described herein.

In online data systems, such as social data networks, correctly identifying attributes of a person or people are important. For example, correct identification of a person is used for data security, targeted digital advertising, and customized data content, among other things. Segmentation consists of dividing an audience into groups of people with common needs or preferences who are likely to react to an ad in the same way. The rapid growth of social media has sparked in recent years increasing interests in the research and development of techniques for segmenting online users based on their demographic features.

It is also recognized that in typical social media networks or platforms, only a small percentage (e.g. 2-5%) of user accounts have demographic information accurately disclosed on their user account profiles. Trying to compute the demographic information for users that is highly accurate, is a difficult computing problem given such limited data. In particular, inferring the correct gender associated with a user account is difficult.

For a computing system to determine a gender for a user account, the technical difficulty is increased when there is little self-published information about the user. For example, a user may not publish text or digital photos about themselves, thereby providing little data for a computing system to compute a gender determination.

Furthermore, even if the data is provided, it is herein recognized that the gender information may be false. For example, users in social data networks may create false accounts. Accurately determining the gender based on the self-published information, therefore, may not be reliable.

The proposed computing systems and methods use high performance classifiers for identifying the gender of social media users. In particular, the identification of a gender attribute for a given user is based on the male to female gender ratios associated with certain seed users, and the given user follows these certain seed users. This computation approach includes using the connections identified in a social data network.

For example, in a social data network, such as Twitter, a given user may follow a celebrity, such as Justin Bieber, who has 80 million followers. Of these followers, for example, 10% are male and 90% are female. Therefore, if the given user follows Justin Bieber, there is a high chance that the given user is female. However, it is herein recognized that accurately determining the ratio of male to female followers for Justin Bieber, or another popular user account, is difficult. The computing system described herein and the related computations address these difficulties.

Social data networks, also called social networking platforms, include users who generate and post content for others to see, hear, etc (e.g. via a network of computing devices communicating through websites associated with the social networking platform). Non-limiting examples of social networking platforms are Facebook, Twitter, LinkedIn, Pinterest, Tumblr, Snapchat, blogospheres, websites, collaborative wikis, online newsgroups, online forums, emails, and instant messaging services. Currently known and future known social networking platforms may be used with principles described herein.

The term “post” or “posting” refers to content that is shared with others via social data networking. A post or posting may be transmitted by submitting content on to a server or website or network for other to access. A post or posting may also be transmitted as a message between two devices. A post or posting includes sending a message, an email, placing a comment on a website, placing content on a blog, posting content on a video sharing network, and placing content on a networking application. Forms of posts include text, images, video, audio and combinations thereof. In the example of Twitter, a tweet is considered a post or posting.

The term “follower”, as used herein, refers to a first user account (e.g. the first user account associated with one or more social networking platforms accessed via a computing device) that follows a second user account (e.g. the second user account associated with at least one of the social networking platforms of the first user account and accessed via a computing device), such that content posted by the second user account is published for the first user account to read, consume, etc. For example, when a first user follows a second user, the first user (i.e. the follower) will receive content posted by the second user (i.e. a followee). In some cases, a follower engages with the content posted by the other user (e.g. by sharing or reposting the content). A followee may also be called a friend.

In the proposed system and method, edges or connections, are used to develop a network graph and several different types of edges or connections are considered between different user nodes (e.g. user accounts) in a social data network. These types of edges or connections include: (a) a follower relationship in which a user follows another user; (b) a re-post relationship in which a user re-sends or re-posts the same content from another user; (c) a reply relationship in which a user replies to content posted or sent by another user; and (d) a mention relationship in which a user mentions another user in a posting.

In a non-limiting example of a social network under the trade name Twitter, the relationships are as follows:

Re-tweet (RT): Occurs when one user shares the tweet of another user. Denoted by “RT” followed by a space, followed by the symbol @, and followed by the Twitter user handle, e.g., “RT @ABC followed by a tweet from ABC).

@Reply: Occurs when a user explicitly replies to a tweet by another user. Denoted by ‘@’ sign followed by the Twitter user handle, e.g., @username and then follow with any message.

@Mention: Occurs when one user includes another user's handle in a tweet without meaning to explicitly reply. A user includes an @ followed by some Twitter user handle somewhere in his/her tweet, e.g., Hi @XYZ let's party @DEF @TUV

These relationships denote an explicit interest from the source user handle towards the target user handle. The source is the user handle who re-tweets or @replies or @mentions and the target is the user handle included in the message. It will be appreciated that the nomenclature for identifying the relationships may change with respect to different social network platforms. While examples are provided herein with respect to Twitter, the principles also apply to other social network platforms.

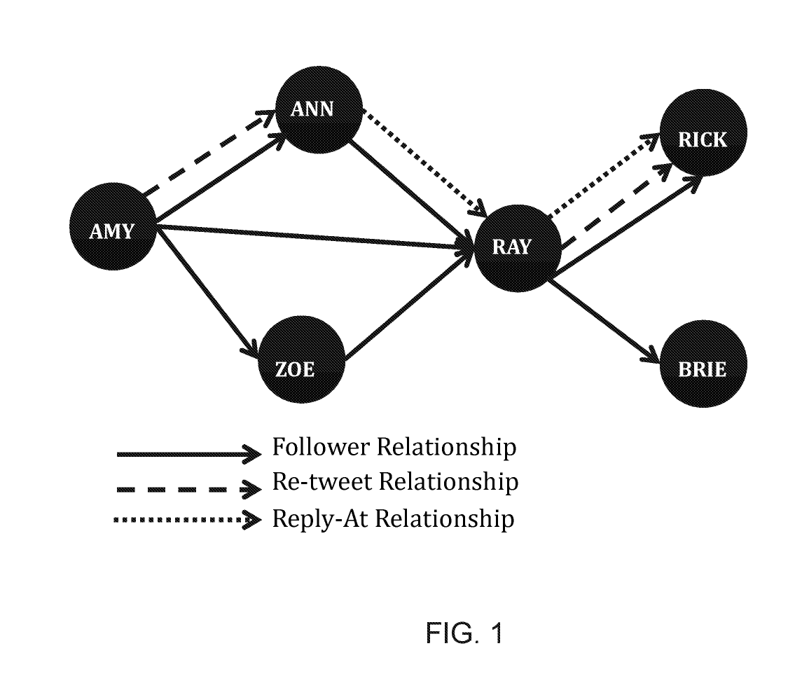

To illustrate the proposed approach, consider the network graph in FIG. 1, which depicts the user accounts of Ann, Amy, Ray, Zoe, Rick and Brie as nodes. Their relationships are represented as directed edges between the nodes. The computing system analyzes the text content (e.g. re-tweets, posts, replies, tweets, shares, etc.) between the users to determine “textual similarity”.

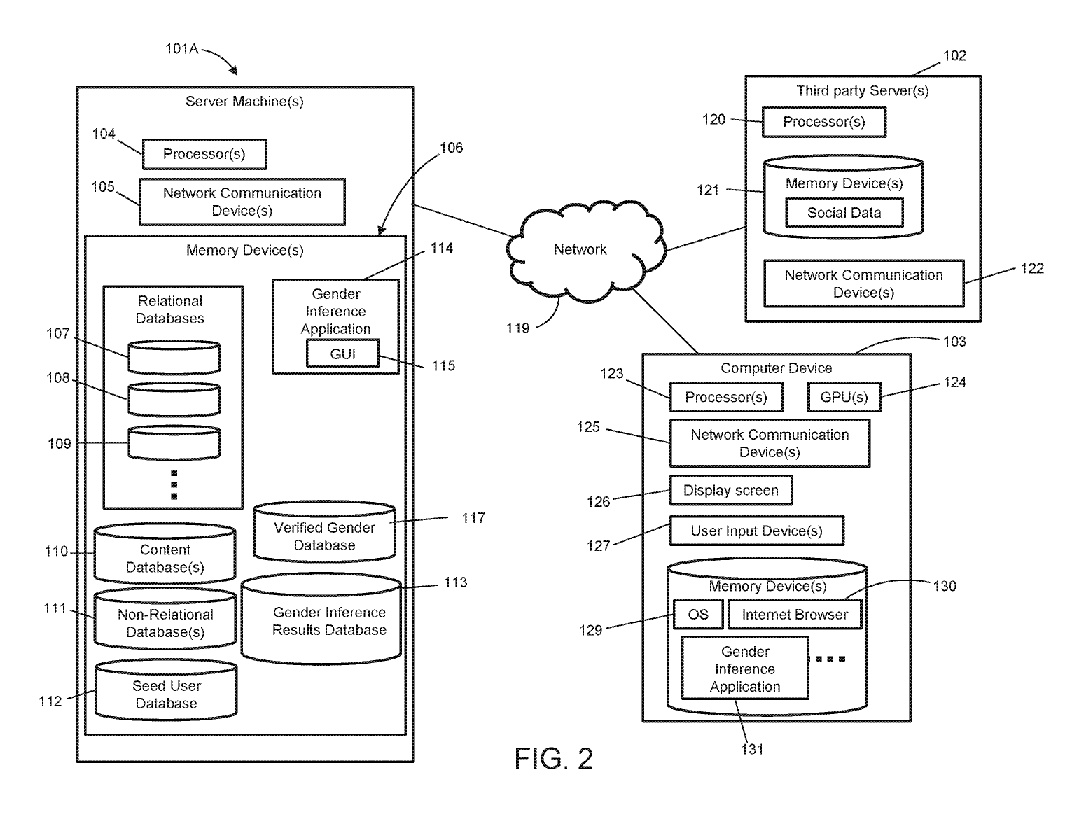

Turning to FIG. 2 an example embodiment of a server system 101A is provided for inferring a gender attribute of a user. The server system 101A may also be called a computing system.

The server system 101A includes one or more processors 104. In an example embodiment, the server system includes multi-core processors. In an example embodiment, the processors include one or more main processors and one or more graphic processing units (GPUs). While GPUs are typically used to process images (e.g. computer graphics), in this example embodiment they are used herein to process social data. For example, the social data is graph data (e.g. nodes and edges).

The server system also includes one or more network communication devices 105 (e.g. network cards) for communicating over a data network 119 (e.g. the Internet, a closed network, or both).

The server system further includes one or more memory devices 106 that store one or more relational databases 107, 108, 109 that map the activity and relationships between user accounts. The memory further includes a content database 110 that stores data generated by, posted by, consumed by, re-posted by, etc. users. The content includes text, images, audio data, video data, or combinations thereof. The memory further includes a non-relational database 111 that stores friends and followers associated with given users. The memory further includes a seed user database 112 that stores seed user accounts having known genders, and a gender inference results database 113. Also stored in memory is a verified gender database 117, which stores an initial set of user accounts having verified gender data.

The memory 106 also includes a gender inference application 114.

For clarity, user accounts and users may be herein used interchangeably. Furthermore, the various relationships in a social data network may herein be generalized as a “follower” or “follower relationship”.

The server system 101A may be in communication with one or more third party servers 102 over the network 119. Each third party server having a processor 120, a memory device 121 and a network communication device 122. For example, the third party servers are the social network platforms (e.g. Twitter, Instagram, Facebook, Snapchat, etc.) and have stored thereon the social data, which is sent to the server system 101A.

In an example embodiment, at least one of the third party servers 102 hosts a reputable information website that contains information about people (e.g. Wikipedia website, a newspaper website, IMDB website, etc.). In another aspect, at least one of the third party servers hosts a name database or name website that associates names with gender. For example, baby name websites host name databases that list names associated with a gender (e.g. Boys names are: John, Timothy, Edward, etc.; and girls names are: Jane, Sarah, Rebecca, etc.).

The server system 101A may also be in communication with one or more user computing devices 103 (e.g. mobile devices, wearable computers, desktop computers, laptops, tablets, etc.) over the network 119. The computing device, for example, includes one or more processors 123, one or more GPUs 124, a network communication device 125, a display screen 126, one or more user input devices 127, and one or more memory devices 128. The computing device has stored thereon, for example, an operating system (OS) 129, an Internet browser 130 and a gender inference application 131. In an example embodiment, the gender inference application 114 on the server is accessed by the computing device 103 via the Internet Browser 130. In another example embodiment, the gender inference application 114 is accessed by the computing device 103 via its local demographic inference application 131. While the GPU 124 is typically used by the computing device for processing graphics, the GPU 124 may also be used to perform computations related to the social media data.

It will be appreciated that the server system 101A may be a collection of server machines or may be a single server machine.

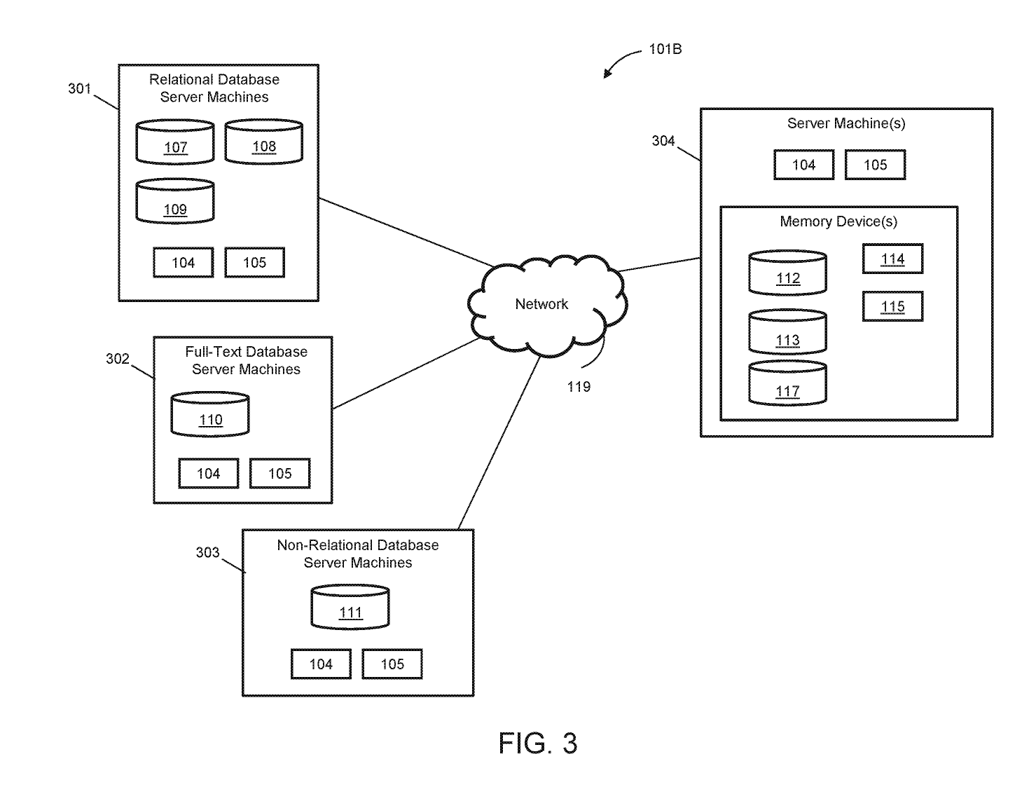

Turning to FIG. 3, an alternative example embodiment to the server system 101A is shown as multiple server machines in the server system 101B. The server system 101B includes one or more relational database server machines 301, that store the databases 107, 108 and 109. The system 101B also includes one or more full-text database server machines 302 that stores the database 110. The system 101B also includes one or more non-relational database server machines 303 that store the database 111. The system 101B also includes one or more server machines 304 that store the databases 112, 113, 117 and the applications or modules 114 and 115.

It will be appreciated that the distribution of the databases, the applications and the modules may vary other than what is shown in FIGS. 2 and 3.

For simplicity, the example embodiment server systems 101A or 101B, or both, will hereon be referred to using the reference numeral 101.

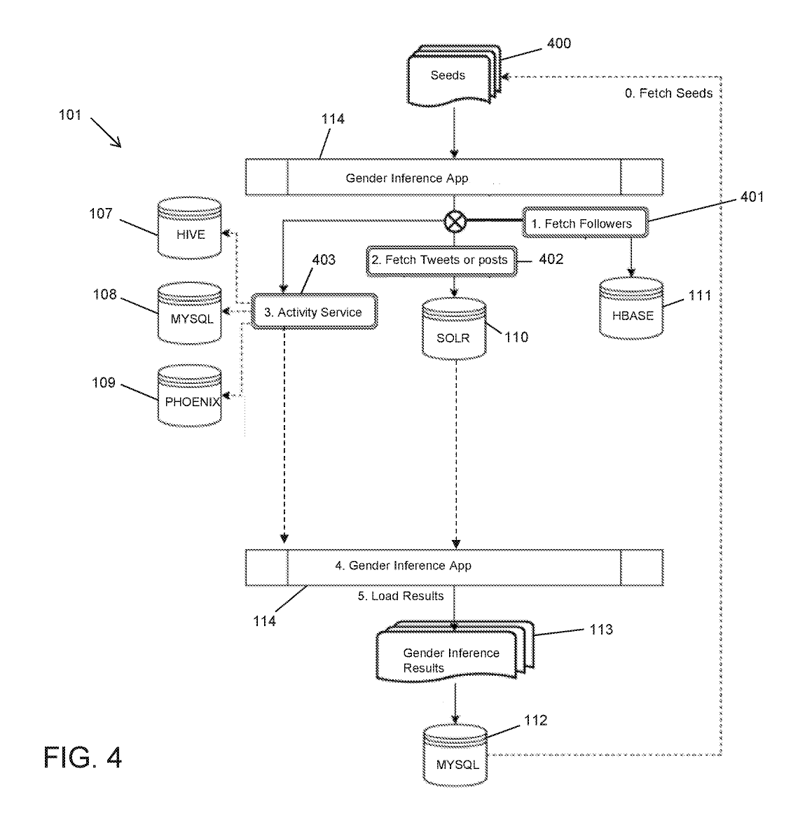

FIG. 4 shows an example architecture of the server system 101 and the flow of data amongst databases and modules.

As an initial step, the server system 101 obtains one or more seed user accounts (also called seeds or seed users) 400 from the database 112. In an example embodiment, the seed users accounts are those accounts in a social networking platform having known demographic attributes. The database 112, for example, is a MYSQL type database.

The one or more seeds 400 are passed by the server system 101 into its demographic inference application 114.

Responsive to receiving the seeds 400, the gender inference application 114 obtains followers (block 401) of one or more given seeds. The followers, for example, are obtained by accessing the database 111, which for example is an HBASE database.

In this example implementation, an HBASE distributed Titan Graph database 111 runs on top of a Hadoop Distributed File System (HDFS) to store the social network graph (e.g., in a server cluster configuration comprising fifteen server machines). In other words, in an example implementation, the server machines 303 comprises multiple server machines that operate as a cluster.

In the example embodiment, the computing system may access the Tweets or other posts (block 402) to determine if there is a follower relationship.

In this example implementation, the content database 110 is a SOLR type database. SOLR is an enterprise search platform that runs as a standalone full-text server 302. It uses the Lucene Java search library as its core for full-text indexing and search.

In an example embodiment, responsive to receiving the seeds 400, the application 114 may further access one or more of the relational databases 107, 108, 109 to determine the activity service of the seeds and the subject user (block 403). The activity service includes the replies, repost, posts, mentions, follows, likes, dislikes, etc. between the subject user and the one or more seed users, and may be used to determine if a follower relationship exists.

It will be appreciated that there are multiple ways for a computing system to obtain or determine via computation, whether or not there is a follower relationship between user accounts in a social data network.

In this example embodiment, the databases 107, 108, 109 are respectively a HIVE database, a MYSQL database and a PHOENIX database. HIVE is a data warehouse infrastructure built on top of Hadoop for providing data summarization, query, and analysis. MYSQL is a relational database management system. PHOENIX is a massively parallel, relational database layer on top of noSQL stores such as Apache HBase. Phoenix provides a Java Database Connectivity (JDBC) driver that hides the intricacies of the noSQL store enabling users to create, delete, and alter SQL tables, views, indexes, and sequences; upsert and delete rows singly and in bulk; and query data through SQL.

The application 114 stores the inferred gender result in the database 113.

The inferred gender result may be used to update the genders of the subject users in other databases, including but not limited to the followers associated with the users in the seed database 112.

The above computing systems are for example. Other computing systems and computing architectures that are configured to store and process the social network data to determine the most probable gender of as many user accounts as possible, are also applicable to the principles described herein.

In general, the computing system 101 obtains the male:female (M:F) follower ratio associated with certain users, the ratio obtained from a sample of followers of those users. That ratio, and in particular a weighted sum of those ratios, is used to compute a gender of their other followers. For example, if a user Alice has 7:3 M:F follower ratio, and a user Bob has a 6:4 M:F follower ratio, and the user Cody follows both Alice and Bob, then the computing system determines that Cody is a male with a probability of (0.7+0.6)/2=0.65, and that Cody is a female with a probability of 0.35.

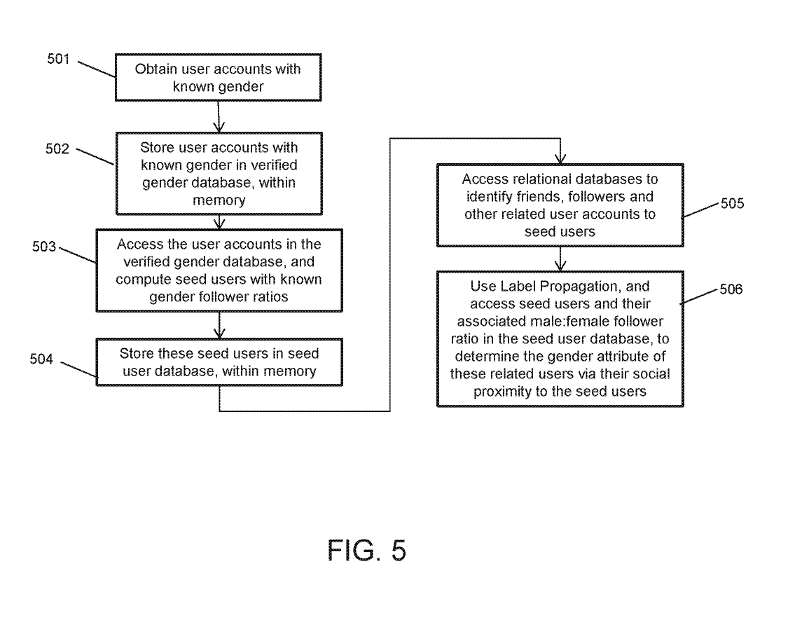

FIG. 5 shows an example of processor executable instructions for determining the gender using label propagation over a social data network.

At block 501, the computing system obtains user accounts with known gender. At block 502, the computing system stores user accounts with known gender in verified gender database 117, within memory. At block 503, the computing system accesses the user accounts in the verified gender database 117, in order to compute seed users with known gender follower ratios. At block 504, the computing system stores these seed users in a seed user database 112, within memory. At block 505, the computing system accesses one or more relational databases to identify friends, followers and other related user accounts to seed users. At block 506, the computing system uses label propagation, and accesses seed users and their associated male:female follower ratio in the seed user database, to determine the gender attribute of these related users via their social proximity to the seed users.

In an example embodiment, the gender attribute may be represented as a probability number associated with male and female. In another example embodiment, the gender attribute is represented as male, or similar symbol, if the probability of male is greater than female, or, in another example, greater than a threshold T. For example T may be 0.65. Similarly, the gender attribute is represented as female, or similar symbol, if the probability of female is greater than male, or, in another example, greater than the threshold T.

These computed gender values may be used by the application 114 to determine the inferred gender attribute of the given user account, which is then processed for display via the GUI 115. The graphical result in the GUI is transmitted over the network 119, for example, to a user computing device 103 for display thereon (e.g. on its display screen 126).

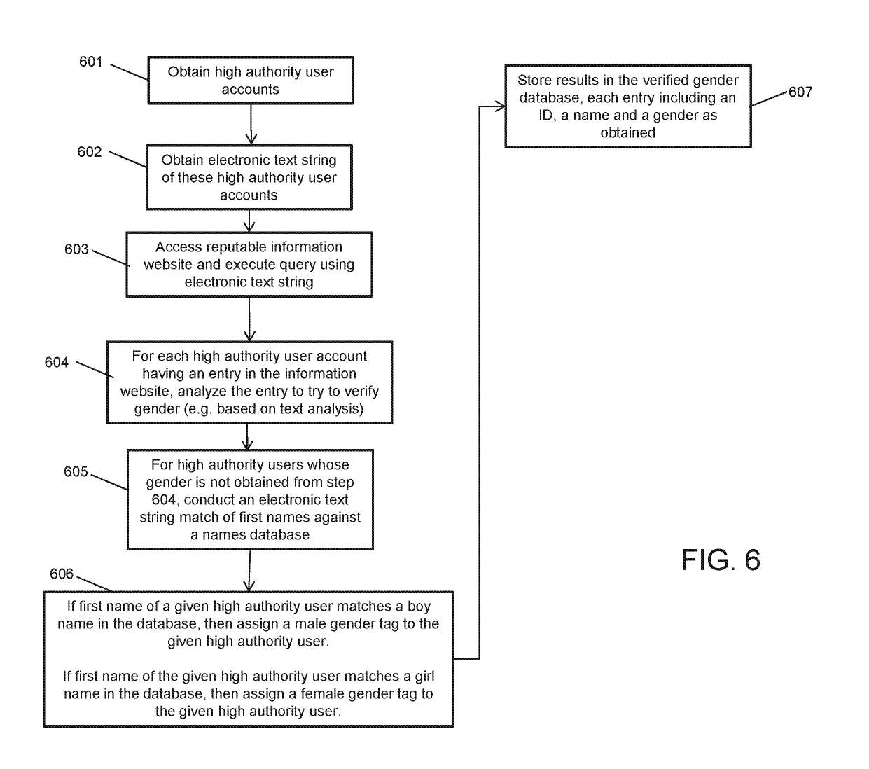

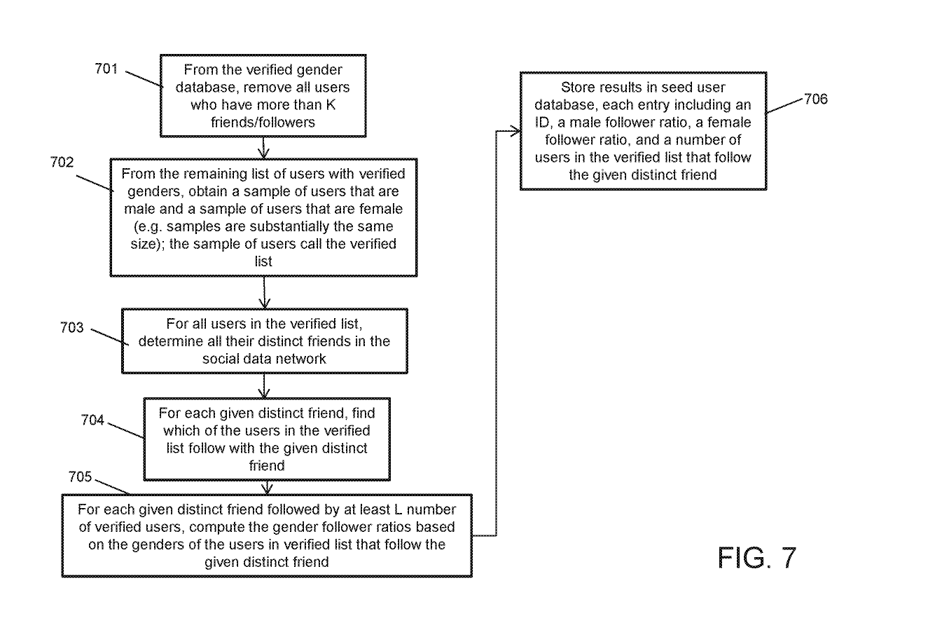

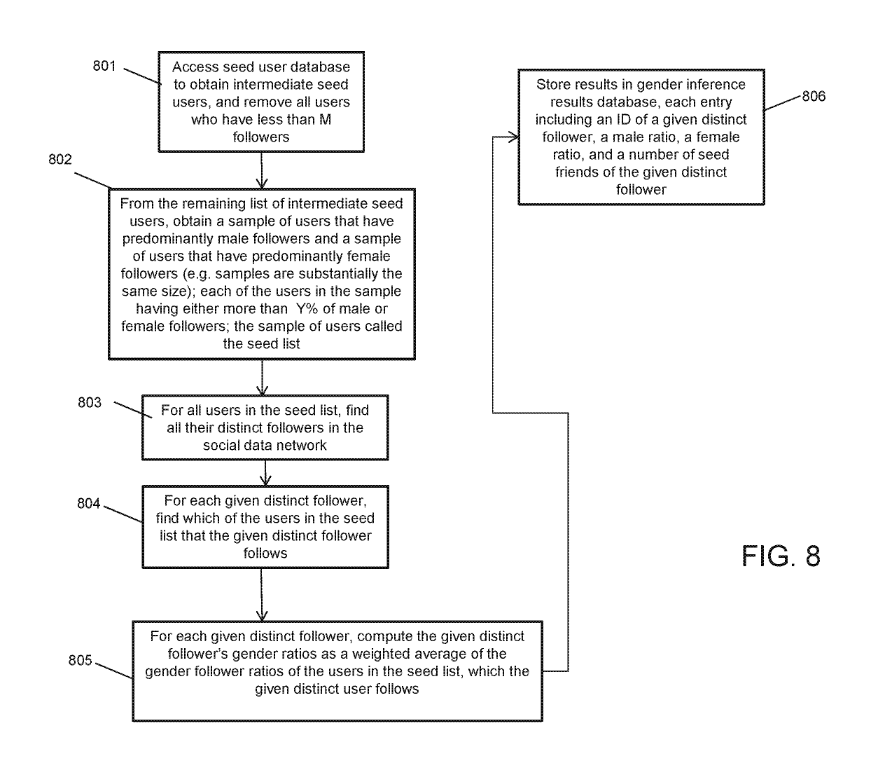

FIG. 6 provides an example of detailed executable instructions to implement blocks 501 and 502; FIG. 7 provides an example of detailed executable instructions to implements blocks 503 and 504; and FIG. 8 provides an example of detailed executable instructions to implement blocks 505 and 506.

Turning to FIG. 6, the executable instructions are used to compute a list of user accounts whose gender are known (with high confidence).

At block 601, the computing system obtains a list of all high authority (>=5) accounts on Twitter, or some other social data network. Preferably, but not necessarily, five or more high authority user accounts are obtained. This can be done, for example, by querying the MySQL table user_scores in a database, where the user_scores represent an authority value. Other ways may be used to identify high authority users in a social data network. For example, influential users or users considered to be experts may be used to determine high authority users. For example, users accounts belonging to Justin Bieber, President Obama, and Dr. Stephen Hawking are considered as high authority users.

At block 602, the computing system obtains the actual electronic text string names of these high authority accounts. For example, this can be done by searching the name field associated with their user accounts.

At block 603, the computing system then accesses one or more information websites (e.g. hosted by a third party server 102) and submits the electronic text string of the name as a search term, thereby executing a query. For example, a search for the high authority users is performed on the wiki mongo database (created from the Wikipedia data dumped on DBpedia). Other non-limiting examples of information websites include www.IMDB.com and www.wikipedia.com.

At block 604, for each high authority user account having an entry in the intersection of Twitter high authority accounts and the website, as returned by the query, the computing system determines their gender from the website. For example, President Obama appears in the mongo database, and his gender is automatically computed by counting the number of occurrences of “he” vs “she” (e.g. also including “his” vs “her”) in the corresponding Wiki extended abstract of that President Obama. As there will be more instances of “he” for President Obama, his user account is confirmed to be associated with a male gender attribute. In a general example embodiment, text analysis of the text on the website about the given person is used to determine the gender of that given person.

Some of the high authority users may not be searchable in the one or more information websites. Therefore, at block 605, for each of the remaining high authority users whose gender is not obtained in block 604, the computing system performs an exact string match of their first names against a given list of male and female names. This is performed, for example, by accessing a names database or a names website for baby names, which shows names associated with boys or girls (e.g. male or female). As per block 606, if the user's first name is found in the list of male names, the computing system identified the user a male. If the user's first name is found in the list of female names, the computing system considers the user a female.

At block 607, the computing system stores the results in the verified gender database, each entry including an ID, a name and a gender as obtained. In an example embodiment, the data is stored in a table called VerifiedGender in the following json format:

{

ID: TwitterID of high authority account a
Name: Actual name of the person in the format firstname_lastname

(all lower case)

Gender: Gender of a as obtained above

}

Turning to FIG. 7, the computing system obtains a list of seed users whose gender follower ratios are known (with high confidence) given a list of users whose gender are known (with high confidence). These list of users whose gender are known were determined in FIG. 6.

At block 701, from the list of users whose gender are known, the computing system removes all users who have more than K friends (e.g. followees), as they follow too many people to provide any meaningful information. For example, K=10000. However, the value of K may be different.

At block 702, from the remaining list of users whose gender are known, the computing system gets a sample of (e.g. nearly or substantially) equal number of males and females. This is called the Verified list.

At block 703, for all users in this Verified list, the computing system finds all their distinct friends on the social data network (e.g. Twitter).

In an example embodiment, the term “distinct friend” refers to a unique user account. For example, Alice and Bob are users in the Verified list. Alice has friends John and Jane, and Bob has friends Jane and Mike. In determining the distinct friends, Jane is not counted twice, and therefore the distinct friends of Alice and Bob are John, Jane and Mike.

At block 704, for each given distinct friend, the computing system determines which of the users in the Verified list follow the given distinct friend.

At block 705, for each given distinct friend who is followed by at least L number of users in the Verified list, the computing system computes the given distinct friend's gender follower ratios from the gender details of the users in the Verified list that follow the given distinct friend. In an example embodiment, L is 10. These ratios, for example, are averaged together.

At block 706, the computing system stores these results in a seed user database, each entry including an ID, a male follower ratio, a female follower ratio, and a number of users in the verified list that follow the given distinct friend.

In an example implementation, the results are stored in a table called SeedsGender in the following json format:

{

ID: TwitterID of friend a
MaleFollowerRatio: Follower_Ratio_Male
FemaleFollowerRatio: Follower_Ratio_Female
NumberOfVerifiedFollowers: Number of followers of friend a in the
Verified list

}

Turning to FIG. 8, the computing system obtains the most likely gender of as many users as possible, given a list of seeds whose gender follower ratios are known.

In particular, at block 801, the computing system accesses the seed user database to obtain intermediate seed users, and remove all users who have less than M number of followers. In this way, users that are followed by too few people are removed as they do not provide meaningful information. In an example embodiment, M is 500.

At block 802, from the above list, sample (e.g. nearly or substantially) equal number of people who have either more (>Y) male followers or more (>Y) female followers. This is called the Seed list. In an example embodiment, Y is 60%. In an example embodiment, from the remaining list of intermediate seed users, the computing system obtains a first sample of users that have predominantly male followers and a second sample of users that have predominantly female followers. In further example aspect, the first sample of user and the second sample of users are substantially equal in number.

At block 803, for all users in this Seed list, the computing system identifies all their distinct followers on the social data network.

At block 804, for each given distinct follower, the computing system determines which of the users in the Seed list that the given distinct follower follows.

At block 805, for each given distinct follower, the computing system computes the gender ratios of the given distinct follower as a weighted average of the gender follower ratios of the users in the Seed list that the given distinct follower follows.

For example, the corresponding weights are computed as per below:
weight of seed friend s=min(2000, nₛ),
where nₛ=NumberOfVerifiedFollowers of seed s.

Consider the following non-limiting example that uses weights to compute the weighted average. Assume C follows the seeds A and B. Assume A has a total of 3000 verified followers and B has a total of 1000 verified followers. Then the weight of A is min(2000, 3000)=2000, and the weight of B is min(2000, 1000)=1000. Also, assume that A has Male:Female follower ratio to be 70:30, and B has Male:Female follower ratio to be 60:40. Then, the gender ratios for C is computed as follows: male ratio of C=(0.7*2000+0.6*1000)/(2000+1000)=0.67, and the female ratio of C=(0.3*2000+0.4*1000)/(2000+1000)=0.33.

At block 806, the computing system stores these results in a gender inference results database, each entry including an ID of a given distinct follower, a male ratio, a female ratio, and a number of seed friends of the given distinct follower.

In an example implementation, the results are stored in the following json format:

{

ID: TwitterID of follower a
MaleRatio: Ratio_Male
FemaleRatio: Ratio_Female
NumberOfSeedFriends: Number of friends of follower a in the Seed
list

}

In an example embodiment, the computations in blocks 804 to 806 occur in parallel for each given distinct follower. In other words, the computations for each distinct follower start at block 804 are independent from other distinct followers. In a non-limiting example embodiment, these computations are executed using Apache Spark, which is a cluster computing framework for massively parallel computer processing.

It will be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the computing systems described herein or any component or device accessible or connectable thereto. Examples of components or devices that are part of the computing systems described herein include server system 101, third party server(s) 102, and computing devices 103. Any application or module herein described may be implemented using computer readable/executable instructions that may be stored or otherwise held by such computer readable media.

Examples embodiments and related aspects are below.

In an example embodiment, a computing system is provided comprising: a communication device configured to retrieve at least social network data comprising user accounts; one or more memory devices storing at least a relational database, a verified gender database, a seed user database, and a results database; and one or more processors. The one or more processors are configured to at least: verify gender data of user accounts by submitting a name query via the communication device, and store the user accounts with the verified gender data in the verified gender database; access the user accounts in the verified gender database to compute seed user accounts and corresponding male:female follower ratios; store the seed user accounts and corresponding male:female follower ratios in the seed user database; access the relational database to determine followers of the seed user accounts; and access and use the seed user accounts and their associated male:female follower ratio in the seed user database, to determine a gender attribute of the followers of the seed user accounts.

In an example aspect, each follower of the seed user accounts must follow at least a certain number of seed user accounts.

In another example aspect, verifying gender data of a given user account comprises: obtaining an electronic text string representing the name of the given user account; accessing an information website and submitting a query on the information website using the electronic text string; and analyzing text in a resulting data entry on the information website to obtain the verified gender data of the given user account.

In another example aspect, the resulting data entry includes at least one of “his”, “he”, “her” and “she”.

In another example aspect, verifying the gender data of a given user account comprises: obtaining an electronic text string representing the name of the given user account; and conducting an electronic text string search of a first names database, the first names database comprising boy first names and girl first names; and wherein, if the electronic text string of the given user account matches a boy first name in the first names database, then assigning a male gender tag to the given user account; and if the electronic text string of the given user account matches a girl first name in the first names database, then assigning a female gender tag to the given user account.

In another example aspect, the verified gender data comprises an ID of a given user account, a name and a gender of the given user account as obtained.

In another example aspect, a given seed user account is a friend of multiple ones of the user accounts in the verified gender database, and computing the given seed user account further comprises: determining that the given seed user account is followed by at least L number of user accounts in the verified gender database; and computing a corresponding male:female follower ratio based on the genders of user accounts in the verified gender database that follow the given seed user account.

In another example aspect, the seed user accounts and the corresponding male:female follower ratios comprise: an ID of a given seed user account, a male:female follower ratio associated with the given seed user account, and a number of the user accounts in the verified gender database that follow the given seed user account.

In another example aspect, determining a gender of a given follower of the seed user accounts comprises: computing the given follower's male:female ratios as a weighted average of the male:female follower ratios of the seed user accounts, which the given follower follows; and identifying one of the genders associated with a higher follower ratio.

In another example aspect, computations for determining the gender attribute of the followers of the seed user accounts are executed in parallel for each of the given followers using a cluster computer framework of the computing system.

It will be appreciated that one or more computer readable mediums may include the executable instructions and the data, that when executed by a computing system, perform the computations described herein.

It will be appreciated that different features of the example embodiments of the system and methods, as described herein, may be combined with each other in different ways. In other words, different devices, modules, operations and components may be used together according to other example embodiments, although not specifically stated.

The steps or operations in the flow diagrams described herein are just for example. There may be many variations to these steps or operations without departing from the spirit of the invention or inventions. For instance, the steps may be performed in a differing order, or steps may be added, deleted, or modified.

Although the above has been described with reference to certain specific embodiments, various modifications thereof will be apparent to those skilled in the art without departing from the scope of the claims appended hereto.

1. A computing system for computing gender associated with user accounts in a social data network, the computing system comprising:
a communication device configured to retrieve at least social network data comprising user accounts;
one or more memory devices storing at least a relational database, a verified gender database, a seed user database, and a results database; and
one or more processors configured to at least:
verify gender data of user accounts by submitting a name query via the communication device, and storing the user accounts with the verified gender data in the verified gender database;
access the user accounts in the verified gender database to compute seed user accounts and corresponding male:female follower ratios;
store the seed user accounts and corresponding male:female follower ratios in the seed user database;
access the relational database to determine followers of the seed user accounts; and
access and use the seed user accounts and their associated male:female follower ratio in the seed user database, to determine a gender attribute of the followers of the seed user accounts.

2. The computing system of claim 1 wherein each follower of the seed user accounts must follow at least a certain number of seed user accounts.

3. The computing system of claim 1 wherein verifying gender data of a given user account comprises: obtaining an electronic text string representing the name of the given user account; accessing an information website and submitting a query on the information website using the electronic text string; and analyzing text in a resulting data entry on the information website to obtain the verified gender data of the given user account.

4. The computing system of claim 3 wherein the resulting data entry includes at least one of “his”, “he”, “her” and “she”.

5. The computing system of claim 1 wherein verifying the gender data of a given user account comprises: obtaining an electronic text string representing the name of the given user account; and conducting an electronic text string search of a first names database, the first names database comprising boy first names and girl first names; and wherein
if the electronic text string of the given user account matches a boy first name in the first names database, then assigning a male gender tag to the given user account; and
if the electronic text string of the given user account matches a girl first name in the first names database, then assigning a female gender tag to the given user account.

6. The computing system of claim 1 wherein the verified gender data comprises an ID of a given user account, a name and a gender of the given user account as obtained.

7. The computing system of claim 1 wherein a given seed user account is a friend of multiple ones of the user accounts in the verified gender database, and computing the given seed user account further comprises: determining that the given seed user account is followed by at least L number of user accounts in the verified gender database; and computing a corresponding male:female follower ratio based on the genders of user accounts in the verified gender database that follow the given seed user account.

8. The computing system of claim 1 wherein the seed user accounts and the corresponding male:female follower ratios comprise: an ID of a given seed user account, a male:female follower ratio associated with the given seed user account, and a number of the user accounts in the verified gender database that follow the given seed user account.

9. The computing system of claim 1 wherein determining a gender of a given follower of the seed user accounts comprises: computing the given follower's male:female ratios as a weighted average of the male:female follower ratios of the seed user accounts, which the given follower follows; and identifying one of the genders associated with a higher follower ratio.

10. The computing system of claim 1 wherein computations for determining the gender attribute of the followers of the seed user accounts are executed in parallel for each of the given followers using a cluster computer framework of the computing system.

11. One or more non-transitory computer readable mediums for computing gender associated with user accounts in a social data network, the one or more non-transitory computer readable mediums comprising computer executable instructions that, when executed, cause a computing system to at least:
retrieve at least social network data comprising user accounts;
verify gender data of user accounts by initiating a name query;
storing the user accounts with the verified gender data in a verified gender database;
access the user accounts in the verified gender database to compute seed user accounts and corresponding male:female follower ratios;
store the seed user accounts and corresponding male:female follower ratios in a seed user database;
access a relational database to determine followers of the seed user accounts; and
access and use the seed user accounts and their associated male:female follower ratio in the seed user database, to determine a gender attribute of the followers of the seed user accounts.

12. The one or more non-transitory computer readable mediums of claim 11 wherein each follower of the seed user accounts must follow at least a certain number of seed user accounts.

13. The one or more non-transitory computer readable mediums of claim 11 wherein the computer executable instructions for verifying gender data of a given user account comprises: obtaining an electronic text string representing the name of the given user account; accessing an information website and submitting a query on the information website using the electronic text string; and analyzing text in a resulting data entry on the information website to obtain the verified gender data of the given user account.

14. The one or more non-transitory computer readable mediums of claim 13 wherein the resulting data entry includes at least one of “his”, “he”, “her” and “she”.

15. The one or more non-transitory computer readable mediums of claim 11 wherein the computer executable instructions for verifying the gender data of a given user account comprises: obtaining an electronic text string representing the name of the given user account; and conducting an electronic text string search of a first names database, the first names database comprising boy first names and girl first names; and wherein
if the electronic text string of the given user account matches a boy first name in the first names database, then assigning a male gender tag to the given user account; and
if the electronic text string of the given user account matches a girl first name in the first names database, then assigning a female gender tag to the given user account.

16. The one or more non-transitory computer readable mediums of claim 11 wherein the verified gender data comprises an ID of a given user account, a name and a gender of the given user account as obtained.

17. The one or more non-transitory computer readable mediums of claim 11 wherein a given seed user account is a friend of multiple ones of the user accounts in the verified gender database, and the computer executable instructions for computing the given seed user account further comprises: determining that the given seed user account is followed by at least L number of user accounts in the verified gender database; and computing a corresponding male:female follower ratio based on the genders of user accounts in the verified gender database that follow the given seed user account.

18. The one or more non-transitory computer readable mediums of claim 11 wherein the seed user accounts and the corresponding male:female follower ratios comprise: an ID of a given seed user account, a male:female follower ratio associated with the given seed user account, and a number of the user accounts in the verified gender database that follow the given seed user account.

19. The one or more non-transitory computer readable mediums of claim 11 wherein the computer executable instructions for determining a gender of a given follower of the seed user accounts comprises: computing the given follower's male:female ratios as a weighted average of the male:female follower ratios of the seed user accounts, which the given follower follows; and identifying one of the genders associated with a higher follower ratio.

20. The one or more non-transitory computer readable mediums of claim 11 wherein the computer executable instructions for determining the gender attribute of the followers of the seed user accounts are configured to be executed in parallel for each of the given followers using a cluster computer framework of the computing system.

21. A method performed by a computing system, the method for computing gender associated with user accounts in a social data network, the method comprising:
retrieving at least social network data comprising user accounts using a communication device of the computing system;
storing at least a relational database, a verified gender database, a seed user database, and a results database in one or more memory devices of the computing system; and
using one or more processors of the computing system to at least:
verify gender data of user accounts by submitting a name query via the communication device, and storing the user accounts with the verified gender data in the verified gender database;
access the user accounts in the verified gender database to compute seed user accounts and corresponding male:female follower ratios;
store the seed user accounts and corresponding male:female follower ratios in the seed user database;
access the relational database to determine followers of the seed user accounts; and
access and use the seed user accounts and their associated male:female follower ratio in the seed user database, to determine a gender attribute of the followers of the seed user accounts.
